(19) United States
(12) Patent Application Publication
(10) Pub. No.: US 2018/0290506 A1
(43) Pub. Date: Oct. 11, 2018

(54) Cord and Pneumatic Vehicle Tire

(71) Applicant: Continental Reifen Deutschland GmbH, Hannover (DE)

(72) Inventors: Norbert Kendziorra, Garbsen (DE); Christian Weber, Garbsen (DE)

(73) Assignee: Continental Reifen Deutschland GmbH, Hannover (DE)

(21) Appl. No.: 15/768,843

(22) PCT Filed: Jul. 4, 2016
(86) PCT No.: PCT/EP2016/065634

§ 371 Date: Apr. 17, 2018

(30) Foreign Application Priority Data
Oct. 20, 2015 (DE) 10 2015 220 435.9

(51) Int. Cl. B60C 19/08; B60C 9/00; D06M 11/74; D06M 15/693

(52) U.S. Cl. CPC B60C 19/084; B60C 9/0042; B60C 9/005; B60C 2009/0071; D06M 15/693; B60C 2009/0035; D06M 11/74

(57) ABSTRACT

A cord (1) for use in an elastomer product, preferably in a pneumatic tire, comprising a reinforcement system (2) which is made of an electrically nonconductive material and which is sheathed by an electrically conductive layer (5).

Located on the electrically conductive layer (5), covering same, there is a further, electrically insulating layer (6).

The invention relates to a cord for use in an elastomer product, preferably in a pneumatic tire, comprising a reinforcement core which is made of an electrically nonconductive material and which has an electrically conductive coating. The invention further relates to an elastomer product, in particular a pneumatic tire, comprising at least one such cord.

In elastomer products, for example in pneumatic tires, for example in the carcass, the belt and the like, it is usual to use reinforcement systems embedded in rubber mixtures. Electrically nonconductive materials are often used for the reinforcement systems, examples being polyester, rayon, polyamide, aramid, and hybrid cords made of the abovementioned materials. The material and structure of the reinforcement systems are selected to comply with the requirements placed upon the relevant components during use of the tire. It is moreover usual to provide a coating to reinforcement systems, in particular an adhesion promoter, which is likewise electrically nonconductive and is applied in order to improve adhesion of rubber on the exterior periphery of the reinforcement systems, before these are embedded into a rubber mixture.

Low-rolling-resistance mixtures are increasingly used in the sidewall regions, inner ply or carcass rubberization in order to reduce the rolling resistance of pneumatic tires. Mixtures for components of these types are known as “body mixtures”. Hysteresis in these low-rolling-resistance mixtures can be reduced especially by use of inert fillers or of relatively small quantities of carbon black, or by using silica to replace carbon black. The electrical resistance of these mixtures is thus increased, and their electrical conductivity decreases.

DE 10 2010 017 442 A1 discloses a cord of the type mentioned in the introduction which is electrically conductive by virtue of its electrically conductive coating, while the other physical properties of the cord are unchanged. These cords can therefore ensure that particular tire components are electrically conductive, and can prevent accumulation of electrostatic charges.

There have hitherto been only limited possibilities for use of electrically conductive compounds in pneumatic tires and other elastomer products. Electrical connection over relatively large distances through the metallic conductors usually used in other situations is very difficult on account of the local deformations arising in rubber products, in particular in tires, because of limited flexural strength and low extensibility. In the electrically conductive rubber mixtures currently available there is no reliable way of achieving conduction of electrical current for energy supply or for signal transmission. When electrical conductors are in close proximity to one another, an example being the cords provided with an electrically conductive coating in DE 10 2010 017 442 A1, their ability to transmit signals is severely impaired by the partial electrical conductivity of the surrounding rubber material, in particular if this comprises carbon black as filler.

It is an object of the invention to design a cord of the type mentioned in the introduction in a manner that, irrespective of the electrical conductivity of the surrounding rubber matrix, can ensure electrically conductive connection of sensors, actuators and the like incorporated in an elastomer product, for example in order to supply a voltage.

The invention achieves the object in that covering the electrically conductive layer there is a further, electrically insulating layer.

By virtue of the electrically insulating layer provided in the invention as exterior layer, it is possible to embed a plurality of cords alongside one another, or even in contact with one another, into a rubber matrix, even if this is electrically conductive. The cords can also cross one another while having no electrical effect on one another.

In a preferred embodiment of the invention, the cord has a plurality of electrically conductive layers and a plurality of electrically insulating layers in alternating sequence, where the outermost layer is an electrically insulating layer. With this type of design it is possible to achieve mutually independent supply of voltage to two or more electrical loads in the elastomer product by way of these cords, or to achieve mutually independent utilization of the electrically conductive layers for signal transmission.

Electrical conductivity can be ensured by the presence of electrically conductive particles or electrically conductive powder in the electrically conductive layer, an example being carbon black particles, graphite powder or carbon nanotubes. Alternatively, the electrically conductive layer can also consist of said particles or powders.

In order to achieve good electrical insulation, the electrically insulating layer should be free from, or substantially free from, electrically conductive particles.

In order to improve the mechanical properties of the respective electrically insulating layers, these layers can comprise electrically nonconductive fillers, in particular fine-particle silica.

In a preferred embodiment of the invention, production of at least one of the electrically insulating layers and/or of at least one of the electrically conductive layers may have been based on elastomer-containing, in particular latex-containing, solutions or suspensions.

It is preferable that the proportion of electrically conductive particles in a suspension provided for the production of an electrically conductive layer is from 10% by weight to 70% by weight, preferably from 30% by weight to 50% by weight.

It is moreover preferable that the proportion of electrically nonconductive fillers in a suspension provided for the production of an electrically insulating layer is from 10% by weight to 70% by weight, preferably from 30% by weight to 50% by weight.

The invention further provides an elastomer product comprising at least one cord of the invention. It is particularly advantageous to use cords of the invention in a pneumatic tire, for example for signal transmission and/or supply of voltage, in particular in the carcass insert of a pneumatic tire of radial design.

The invention will now be explained in more detail with reference to a diagram of an inventive example.

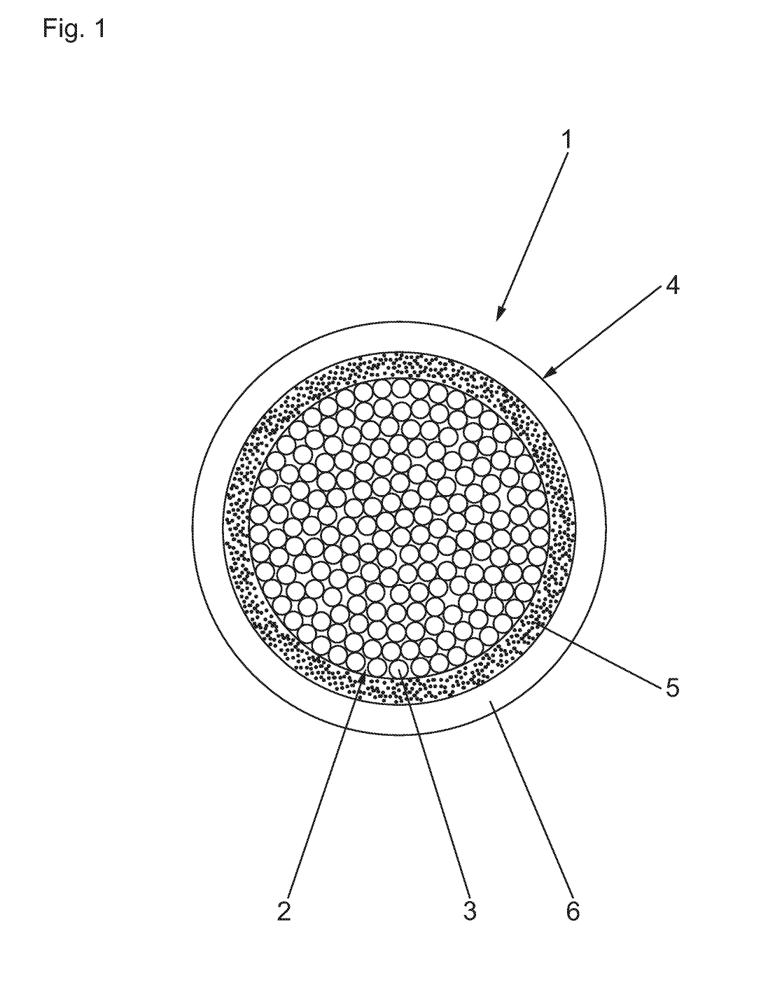

FIG. 1 shows a cross section through an embodiment of an electrically conductive cord.

FIG. 1 shows a cross section through an electrically conductive cord 1 consisting of an externally coated reinforcement core 2. The reinforcement core 2 can be a monofilament, a yarn or a cord consisting of a plurality of yarns. FIG. 1 shows a yarn made of a large number of filaments 3. The reinforcement core 2 consists of non-metallic textile material, for example rayon, polyester, polyamide or aramid, and is therefore electrically nonconductive. The reinforcement core 2 can also consist of various non-metallic materials.

The cord 1 has a multilayer coating 4, which has two layers in the embodiment shown in FIG. 1. The layer 5 located directly on the reinforcement core 2 is electrically conductive, and can consist of carbon black, graphite powder or carbon nanotubes or of an elastomer-containing material which by way of example is based on a latex or on a suspension which comprises another elastomer and which comprises electrically conductive particles which ensure that the layer 5 is electrically conductive, an example being carbon black particles, graphite powder or carbon nanotubes. The layer 5 can by way of example be produced by using a conventional adhesion promoter which comprises carbon black particles and which is sufficiently liquid to permit use of dipcoating to coat the reinforcement core 2. It is possible by way of example to use an RFL dip (resorcinol-formaldehyde latex dip) incorporating carbon black particles, in particular N339 particles or N121 particles. The proportion of electrically conductive particles in the suspension is from 10% by weight to 70% by weight, and particularly preferably from 30% by weight to 50% by weight. The proportion of the dried layer 5 in the cord 1 is from 7% by weight to 20% by weight, preferably about 10% by weight. Sheathing the external side of the electrically conductive layer 5 which surrounds the reinforcement core 2 there is another layer 6, which however is electrically insulating. The electrically insulating layer 6 is by way of example likewise applied by dipcoating to the layer 5. The electrically insulating layer 6 is in particular based on an elastomer-containing solution or suspension, for example a latex solution which preferably no electrically conductive particles, or a suspension in which the concentration of electrically conductive particles, for example carbon black particles, is so small as not to cause any electrical conductivity. Production of the electrically insulating layer 6 can likewise be based on a conventional adhesion promoter liquid, for example an RFL dip. A preferred embodiment uses an elastomer-containing suspension which is by way of example likewise based on latex and which, in particular in order to improve the mechanical properties of the layer 6, comprises electrically nonconductive fillers, in particular fine-particle silica. The proportion of electrically nonconductive fillers in the suspension is from 10% by weight to 70% by weight, preferably from 30% by weight to 50% by weight. The proportion of the dried layer 6 in the cord 1 is from 7% by weight to 20% by weight, preferably about 10% by weight.

The electrically insulating exterior layer 6 permits arrangement of a plurality of cords 1, which are electrically conductive by virtue of the layer 5, alongside one another while these have no electrical effect on one another and on contact do not generate short circuits, in particular in a conductive rubber matrix. Cords 1 coated in the invention can therefore also be arranged so as to cross one another. It is particularly advantageous to use the cords 1 as electrically conductive elements for providing contact to electrical elements, sensors and actuators in rubber products, in particular in pneumatic tires.

In another embodiment of the invention, another electrically conductive layer, similar to the layer 5, can be applied on the exterior layer 6, and a second electrically insulating layer, similar to the layer 6, can be applied thereto. It is thus possible to apply a plurality of electrically conductive and electrically insulating layers in alternation, so that the cord comprises a plurality of separate electrically conductive passageways.

### LIST OF REFERENCE NUMERALS

1 . . . Cord

2 . . . Reinforcement core

3 . . . Filament

4 . . . Coating

5 . . . Layer

6 . . . Layer

1.-11. (canceled)

12. A cord for use in an elastomer product, the cord comprising a reinforcement core which is made of an electrically nonconductive material, wherein the reinforcement core is covered by an electrically conductive layer, wherein disposed upon the electrically conductive layer is an electrically insulating layer, and wherein the electrically conductive layer comprises electrically conductive particles selected from the group consisting of carbon black particles, graphite powder or carbon nanotubes.

13. The cord as claimed in claim 12 comprising a plurality of electrically conductive layers and a plurality of electrically insulating layers, in alternating sequence, wherein the outermost layer is an electrically insulating layer.

14. The cord as claimed in claim 12, wherein the electrically insulating layer is substantially free from electrically conductive particles.

15. The cord as claimed in claim 12, wherein the electrically insulating layer comprises electrically nonconductive particles.

16. The cord as claimed in claim 12, wherein at least one of the electrically insulating layer and electrically conductive layer is based on an elastomer-containing solution or suspension.

17. The cord as claimed in claim 16, wherein the electrically conductive layer is based on an elastomer-containing solution or suspension, and wherein the elastomer-containing solution or suspension comprises from 10% by weight to 70% by weight of the electrically conductive particles.

18. The cord as claimed in claim 16, wherein the electrically insulating layer is based on an elastomer-containing solution or suspension, and wherein the elastomer-containing solution or suspension comprises from 10% by weight to 70% by weight of electrically nonconductive fillers.

19. The cord as claimed in claim 12, as comprised in an elastomer product, and wherein the elastomer product comprises at least one of such cords

20. A cord for use in an elastomer product, the cord comprising a reinforcement core which is made of an electrically nonconductive material, wherein the reinforcement core is covered by an electrically conductive layer, wherein disposed upon the electrically conductive layer is an electrically insulating layer, and wherein the electrically insulating layer comprises electrically nonconductive particles.

21. The cord as claimed in claim 20 comprising a plurality of electrically conductive layers and a plurality of electrically insulating layers, in alternating sequence, wherein the outermost layer is an electrically insulating layer.

22. The cord as claimed in claim 20, wherein the electrically conductive layer comprises electrically conductive particles selected from the group consisting of carbon black particles, graphite powder or carbon nanotubes.

23. The cord as claimed in claim 20, wherein the electrically insulating layer is substantially free from electrically conductive particles.

24. The cord as claimed in claim 20, wherein at least one of the electrically insulating layer and electrically conductive layer is based on an elastomer-containing solution or suspension.

25. The cord as claimed in claim 24, wherein the electrically conductive layer is based on an elastomer-containing solution or suspension, and wherein the elastomer-containing solution or suspension comprises from 10% by weight to 70% by weight of the electrically conductive particles.

26. The cord as claimed in claim 24, wherein the electrically insulating layer is based on an elastomer-containing solution or suspension, and wherein the elastomer-containing solution or suspension comprises from 10% by weight to 70% by weight of electrically nonconductive fillers.

27. The cord as claimed in claim 20, as comprised in an elastomer product, and wherein the elastomer product comprises at least one of such cords

28. A cord for use in an pneumatic tire, the cord comprising a reinforcement core which is made of an electrically nonconductive material, wherein the reinforcement core is covered by an electrically conductive layer, and wherein disposed upon the electrically conductive layer is an electrically insulating layer.

29. The cord as claimed in claim 28, wherein the cord is included in a radial carcass of the pneumatic tire.

30. The cord as claimed in claim 28, wherein the electrically conductive layer comprises electrically conductive particles selected from the group consisting of carbon black particles, graphite powder or carbon nanotubes.

31. The cord as claimed in claim 28, wherein the electrically insulating layer comprises electrically nonconductive particles.
